(19) United States
(12) Patent Application Publication
(10) Pub. No.: US 2025/0085685 A1
(43) Pub. Date: Mar. 13, 2025

(54) METHOD FOR DEPLOYING A MIGRATABLE APPLICATION FOR A PROGRAMMABLE LOGIC CONTROLLER

(71) Applicants: Andreas Burger, Weingarten (DE); Anthony Rowe, Pittsburgh, PA (US); Arne Hamann, Ludwigsburg (DE); Dakshina Narahari Dasari, Renningen (DE); Michael Pressler, Karlsruhe (DE); Nuno Pereira, Pittsburgh, PA (US)

(72) Inventors: Andreas Burger, Weingarten (DE); Anthony Rowe, Pittsburgh, PA (US); Arne Hamann, Ludwigsburg (DE); Dakshina Narahari Dasari, Renningen (DE); Michael Pressler, Karlsruhe (DE); Nuno Pereira, Pittsburgh, PA (US)

(21) Appl. No.: 18/822,632

(22) Filed: Sep. 3, 2024

(30) Foreign Application Priority Data
Sep. 13, 2023 (DE) 10 2023 208 875.4

(51) Int. Cl. G05B 19/05

(52) U.S. Cl. CPC G05B 19/056; G05B 19/058

(57) ABSTRACT

A method for deploying a migratable application for a programmable logic controller. The method includes: converting an application of the programmable logic controller to a general-purpose programming language; modifying the converted application using the general-purpose programming language in order to generate at least one access module to make access of the converted application to at least one sensor and/or at least one actuator possible; compiling the modified application into a bytecode format to deploy the migratable application; executing the migratable application and the application in order to provide an output of the migratable application and an output of the application in order to provide a validation result; validating the migratable application on the basis of a comparison of the output of the migratable application with the output of the application; deploying the validated migratable application on the programmable logic controller, wherein deployment depends on the validation result.

### CROSS REFERENCE

The present application claims the benefit under 35 U.S.C. § 119 of German Patent Application No. DE 10 2023 208 875.4 filed on Sep. 13, 2023, which is expressly incorporated herein by reference in its entirety.

### FIELD

The present invention relates to a method for deploying a migratable application for a programmable logic controller. In addition, the present invention relates to a computer program, a device and a storage medium for this purpose.

### BACKGROUND INFORMATION

Edge computing is, in particular, a distributed computing paradigm, in which computing resources, so-called edge compute nodes or edge devices, can be carried out to process and store data on devices located at or near the edge of a network or of the data source and not in a central data center or in the cloud. Edge computing can make it possible to process data closer to the source, reduce latency, and improve response times. Edge computing or edge-computing-based solutions can therefore be found in Internet of Things (IoT) applications that require data processing and decision-making in real time, such as self-driving cars, or in industrial automation.

The introduction of edge computing in industrial automation can make it possible to monitor, analyze, and control industrial processes in real time, whereby improved efficiency, productivity, and safety are made possible. However, adapting existing industrial automation applications in modern, future-proof edge-computing ecosystems can in particular be a challenge and thus not an easy task.

Industrial control applications are often written in IEC 61131-3, an international standard for programmable controllers (PLC) and associated programming languages. It has been specifically developed by the International Electrotechnical Commission (IEC) and can be used in industrial automation systems. It can define five programming languages, such as ladder diagram (LD), function block diagram (FBD), structured text (ST), sequential function chart (SFC), and instruction list (IL).

The communication between the PLC executing such industrial control applications and the inputs and outputs (I/O) can typically take place via a communication protocol, such as MODBUS; PROFINET or EtherNet/IP. These protocols can make it possible for the PLC to read input values from sensors and transmit output values to actuators and other devices.

The IEC 61131-3 standard can also define a data model for the I/O variables used in the PLC program. In particular, this data model has data types, such as integers, floating-point numbers, and Boolean values, and can make the definition of symbolic names for the I/O variables possible. These I/O variables can typically be used as global variables within the industrial control application.

Existing PLC applications can be executed in customized industrial control runtime environments and are thereby particularly tightly coupled to the software. This can make flexible re-deployment on more powerful devices difficult. Existing PLC applications can also be developed on specific hardware. In addition, existing PLC applications can be written in highly domain-specific languages, such as structured text, ladder diagrams, or functional block diagrams, which may not be easy to extend since they may be tailored to conventional single-core configurations and sequential execution.

### SUMMARY

According to aspects of the present invention, a method, a computer program, a data processing device, and a computer-readable storage medium are provided. Features and details of example embodiments of the present invention arise from the disclosure herein. Features and details described in connection with the method according to the present invention also respectively correspond to the computer program according to the present invention, the data processing device according to the present invention, and the computer-readable storage medium according to the present invention, and vice versa.

According to one aspect of the present invention, a method for deploying a migratable application for a programmable logic controller is provided. According to an example embodiment of the present invention, the method includes the following steps:
converting an application of the programmable logic controller to a general-purpose programming language,
modifying the converted application using the general-purpose programming language in order to generate at least one access module in order to make access of the converted application to at least one sensor and/or at least one actuator possible,
compiling the modified application into a bytecode format in order to deploy the migratable application,
executing the migratable application and the application in order to provide an output of the migratable application and an output of the application,
validating the migratable application on the basis of a comparison of the output of the migratable application with the output of the application in order to provide a validation result,
deploying the validated migratable application on the programmable logic controller, wherein deployment depends on the validation result.

According to an example embodiment of the present invention, a programmable logic controller (PLC) may be an industrial computer suitable for controlling manufacturing processes, such as assembly lines, machines, robotic devices, or an activity requiring high reliability, ease of programming, and process fault diagnosis. PLCs can range from small modular devices with dozens of inputs and outputs (I/O) in a processor-integrated enclosure to large modular rack devices with thousands of I/Os. The term “migratable” may refer to a possibility of migrating the application from one PLC to another PLC without the need to make extensive specific changes, for example with regard to the hardware of the PLC for which the migratable application is intended. The application may be written according to the IEC 61131-3 standard, i.e., in one of the programming languages defined therein. For example, the general-purpose language may be C or C++. In the context of the present invention, the access module may also be referred to as an input/output module or an I/O module. Bytecode may be a form of an instruction set designed for efficient execution by a software interpreter. Bytecode may comprise compact numerical codes, constants, and references, which encode the result of the compiler analysis and of the semantic analysis of things, such as type, extent, and nesting depth of program objects. The migratable application may be executed on the programmable logic controller or, for example, on a runtime of an edge device. The latter case may be preferable since the edge device may provide more additional computing power. The application is preferably executed on the programmable logic controller. The term “validation” may mean that an analysis is carried out with regard to the comparison of the output of the migratable application with the output of the application and that a result thereof may be the validation result. Simply put, if the output of the migratable application and the output of the application are the same or only deviate from one another within a defined threshold value, the validation result may be positive, which may indicate that the migratable application is qualified for deployment on programmable logic controllers. Deploying the validated migratable application on the programmable logic controller may indicate that the validated migratable application is used in place of the application and preferably has access to at least one sensor and/or at least one actuator assigned to the programmable logic controller. The statement that deployment depends on the validation result may mean that deployment can only be carried out if the validation result is positive, which in turn may be the case if the output of the migratable application and the output of the application match or only deviate from one another within a defined threshold. After deployment, the migratable application can be executed on another device, for example on an edge device. The method can thus be provided in a distributed environment with an industrial control device, on which the programmable logic controller and the application can be provided, and at least one edge device, on which the migratable application can be executed, at least for the validation. The method described above can be advantageous insofar as the application can be modified, in particular by the use of the general-purpose language, and/or can more easily be migrated from one PLC to another.

In one example embodiment of the present invention, deployment of the validated migratable application on the programmable logic controller takes place after an execution cycle of the programmable logic controller and within a time period that is shorter than a buffer time of the programmable logic controller. The execution cycle can consist of a time span, which indicates how long it takes to execute the application, and an additional buffer, the so-called buffer time. Deployment within the buffer time can advantageously ensure that the functionality of the programmable logic controller is not limited or delayed by the deployment.

It is possible that the at least one access module is generated in order to provide access to an industrial field bus, wherein access to the industrial field bus is provided by a translation of values of the industrial field bus into messages for the migratable application, and vice versa, in order to make access to the at least one sensor and/or the at least one actuator by means of the industrial field bus possible. This can be advantageous insofar as access to the at least one sensor and/or the at least one actuator takes place without direct access to the at least one sensor and/or the at least one actuator via the industrial field bus but indirectly by means of the messages to and from the migratable application.

In another example embodiment of the present invention, the method furthermore comprises the following step:
generating a validator component for carrying out the validation, wherein the validator component is generated to read the output of the migratable application and the output of the application, wherein output suppression for the migratable application is initiated so that only the application writes values into the industrial field bus.

If the method is implemented in a distributed environment, the validator component may be deployed on its own edge device in order to advantageously reduce the computing demand. Output suppression can advantageously ensure that the migratable application is validated before it is actually used. The output is therefore, in particular, read by the validator component only if output suppression is active. After validation, output suppression can be deactivated.

In another example, the validation furthermore comprises the following steps:
defining a threshold value for a deviation of the output of the migratable application from the output of the application,
comparing a current deviation of the output of the migratable application from the output of the application with the defined threshold value in order to provide the validation result.

The validation result may be positive if the current deviation is below the defined threshold value. The threshold value can advantageously be defined according to specific requirements or an implementation of the programmable logic controller. If no threshold value is defined, the output of the migratable application and the output of the application may need to be the same for the validation result to be positive.

The method may furthermore comprise the following step:
initiating feedback, preferably to a user, wherein the feedback indicates a result of the validation.

The feedback may be output on a user interface, which may comprise a corresponding screen. The feedback to the user can be advantageous insofar as the user can respond to the result accordingly, for example by initiating a countermeasure or by discarding the migratable application at least temporarily. The feedback may be provided on a user interface.

It is possible for the method to furthermore comprise the following step:
initiating a state transmission between the application and the migratable application, wherein initiation depends on the validation result, wherein the state transmission comprises transmission of at least internally used variables within the programmable logic controller and/or internal variables of at least one function module used by the application.

The state transmission may be initiated if the validation result is negative. This may be the case if the output of the migratable application does not match the output of the application or deviates by more than the defined threshold value. The state transmission may indicate and advantageously ensure that the migratable application matches the application. The state transmission may be initiated by an orchestrator if the method is implemented in a distributed environment, wherein the orchestrator may be deployed on a runtime of its own edge device. The orchestrator may be designed to deploy modules at runtime and to undeploy them.

In another aspect of the present invention, a computer program, in particular a computer program product, may be provided, which comprises instructions that, when the computer program is executed by a computer, cause the computer to perform the method according to the present invention. The computer program according to the present invention may thus have the same advantages as described in detail with reference to a method according to the present invention.

In another aspect of the present invention, a data processing device that is designed to perform the method according to the present invention may be provided. The device may, for example, be a computer that executes the computer program according to the present invention. The computer may comprise at least one processor that may be used to execute the computer program. Also provided may be a non-volatile data store in which the computer program may be stored and from which the computer program can be read by the processor in order to be executed.

According to another aspect of the present invention, a computer-readable storage medium may be provided, comprising the computer program according to the present invention and/or instructions that, when executed by a computer, cause the computer to perform the steps of the method according to the present invention. The storage medium may be designed as a data store, for example a hard drive, and/or as a non-volatile memory and/or as a memory card and/or as a solid-state drive. The storage medium may be integrated into the computer, for example.

In addition, the method according to the present invention may be implemented as a computer-implemented method.

Further advantages, features and details of the present invention become apparent from the following description, in which exemplary embodiments of the present invention are described in detail with reference to the figures. The features mentioned in this disclosure can each be essential to the present invention individually or in any combination.

### BRIEF DESCRIPTION OF THE DRAWINGS

FIG. 1 shows a method, a computer program, a storage medium and a device according to example embodiments of the present invention.

FIG. 2 shows a PLC in a possible implementation environment according to example embodiments of the present invention.

### DETAILED DESCRIPTION OF EXAMPLE EMBODIMENTS

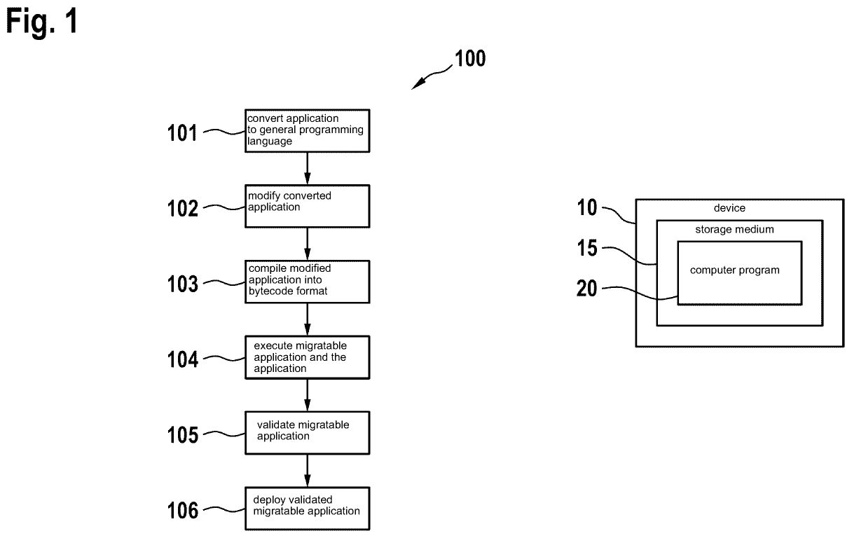

FIG. 1 shows a computer program 20, a storage medium 15 and a device 10 according to embodiments of the present invention.

FIG. 1 furthermore shows a method 100 for deploying a migratable application for a programmable logic controller 1 according to embodiments of the present invention. In a first step 101 of the method 100, an application of the programmable logic controller 1 is converted to a general programming language. In a second step 102, the converted application is modified using the general-purpose programming language in order to generate at least one access module 11 in order to make access of the converted application to at least one sensor 9 and/or at least one actuator 7 possible. In a third step 103, the modified application is compiled into a bytecode format in order to deploy the migratable application. In a fourth step 104, the migratable application and the application are executed in order to provide an output of the migratable application and an output of the application. In a fifth step 105, the migratable application is validated on the basis of a comparison of the output of the migratable application with the output of the application in order to provide a validation result. In a sixth step 106, the validated migratable application is deployed on the programmable logic controller 1, wherein deployment depends on the validation result.

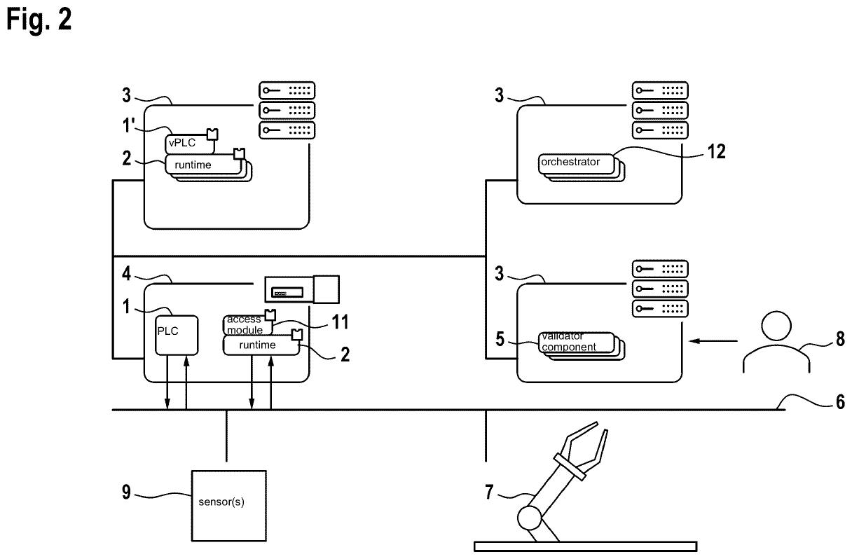

FIG. 2 schematically shows how a PLC 1 can be implemented in a distributed environment with edge devices 3 and an industrial control device 4. The following explanations may relate to the implementation in FIG. 2.

An aspect of the present invention may be a methodology for converting PLC programs to virtualized PLC programs (vPLC 1′), which can be flexibly deployed on an edge device 3 and utilize the computing power of the edge devices 3. One motivation could be that the PLC programs are tightly coupled to particular hardware and software for design reasons and, given the limitations of the current hardware and software, it may not be easy to extend their functionality.

In order to migrate control applications and available installed bases of the customer into this ecosystem and to offer existing customers the advantages of the reliable distributed edge computing ecosystem, such as flexibility, modularity, reliability and use of COTS hardware, it may be important to provide a method for converting IEC 61131-3 applications to general programming languages and an approach for executing these migratable applications in a hardware-independent and operating-system-independent manner. The method may make seamless migration of industrial control applications possible without having to rewrite the IEC 61131-3 applications in a general-purpose programming language. In addition, the method can embed the transformed industrial control application into a hardware-independent and operating-system-independent runtime execution module 2 by abstracting I/O variables to form a generalized I/O communication concept. This abstraction may make it possible to dispense with the use of global I/O variables as a communication interface between I/O applications and IEC 61131-3 applications and to use more flexible communication paradigms, such as messaging. The transformed and abstracted control applications may therefore be more flexible, easier to maintain and to modularize and/or may be distributable over various edge devices 3.

The following method may be embedded into a distributed edge computing ecosystem. This ecosystem may comprise edge devices 3 connected via TSN network switches/normal Ethernet and an industrial automation device 4 capable of connecting to sensors 9 and actuators 7.

On each of the edge devices 3, a runtime 2 may be installed, which may provide a secure isolated sandbox execution environment, in particular with integrated security checks that can also manage internal resource reservations for the edge devices 3 and provide an abstraction of the operating system and hardware. Additionally, a channel concept may be provided in order to decouple the communication between runtime modules 2 from the underlying implementation. In addition, the runtime 2 may use an output suppression mode to control whether or not a module is allowed to publish externally, which may provide the possibility to create a passive hot standby module that receives and processes inputs but does not transmit actuation commands. The runtime 2 itself may be able to execute modules compiled as bytecode, e.g., WebAssembly.

An orchestrator 12 may be required to deploy and manage real-time execution modules (e.g., virtual PLC modules, i.e., migratable applications) on the various runtimes 2 according to application requirements. In addition, it may orchestrate the state transmission by triggering state extractions and state injections in order to ensure that data loss does not occur during the process of taking over control.

A validator component 5 may be used to compare the outputs generated by the virtualized PLC module 1′ and the original PLC module 1. This component may be generated during the translation process since it may depend on the specific translated PLC control code and its virtual translation.

In order to decouple the access to values of sensors 9 and actuators 7 from the underlying industrial field bus 6, an access module 11, which may also be referred to as I/O module 11, may be generated in the course of the transformation process. The access module 11 may make access to I/O values in the runtime 2 communication possible.

In order to achieve a stateful migration of the PLC application/program to the virtual PLC 1′ on the edge device 3, the PLC 1 may have to be equipped with an API that makes read access to the internal memory of the used PLC runtime 2 1 possible. If such an API is not available and the PLC program has internal states (stateful application), the transformation can be carried out, but the user 8 may have to accept a delta between the control values generated by the PLC and the migrated virtual PLC 1′. A stateless PLC program can be transformed without a PLC memory access API.

The state transmission may be implemented via a method call to the memory access API. The memory access API can bundle the internal memory state as a binary blob and then transmit it via TCP (client (orchestrator 12)/server (PLC 1)) using protocol buffers or similar basic messaging/RPC implementations.

The approach is based, for example, on the utilization of available compilers to compile industrial control code, which may, for example, be written in IEC 61131-3, into modern programming languages, such as C, C++, or Rust. The compiled or transformed industrial control code may comprise global variables based on the original I/O variables used to read input values and transmit output values to actuators 7 and other devices. These global variables may then be abstracted by a generic communication concept, for example by modifying the transformed industrial control code with function calls, callbacks, etc. One idea might be to convert the communication paradigm from the shared memory communication to a message-based mechanism that makes it possible for applications to be distributed.

As soon as the industrial control application has been migrated in the manner described, it can be embedded into an HW/OS-agnostic runtime execution module, called vPLC 1′ module. The vPLC 1′ module may comprise glue code that implements the runtime model of the original PLC 1 (task schedule, etc.) and functionalities that may be important in order to implement such a module in a reliable distributed edge ecosystem. The modules can then be compiled into a low-level binary command format for a stack-based virtual machine 7, such as WebAssembly. Using such concepts can make it possible to execute the industrial control application on any hardware (edge devices 3) isolated from the operating system.

A next step could be to compare the equivalence of the vPLC 1′ application, i.e., the migratable application, and the original PLC program, i.e., the application. In the case of complex industrial control applications, the current state of the application may be extracted and added to the vPLC 1′ module, i.e., the migratable application.

This may take place after the vPLC 1′ module, i.e., the migratable application, has been started, and may initially run in parallel with the original PLC program, i.e., the application.

As soon as the original PLC program, i.e., the application, and the vPLC 1′ module, i.e., the migratable application, generate identical output, the orchestrator 3 may initiate the switching from the industrial control device 4 (e.g., the PLC) to the vPLC 1′ module executed in the reliable distributed edge computing ecosystem. In order to support this process, the method may comprise a validator component 5 that can compare the outputs, I/O variables, and channel outputs and highlight possible differences for the operator.

In a first step, the industrial control application may be converted to a modern programming language, i.e., a universal programming language, such as C, C++, or Rust.

In a next step, access to the inputs and outputs defined in the header file and the C file may be replaced by a generalized channel concept. In short, the channel concept may use an underlying messaging paradigm to provide an abstraction for reading sensor 9 inputs and writing actuator 7 outputs. The read-in and read-out values of the real sensor 9 and actuator 7 may therefore be translated into the channel concept that can be used between the various runtime modules 2 and the virtual PLC module (vPLC 1′).

In order to achieve this, the method can generate a so-called access module 11 or I/O module 11, which can have access to the industrial field bus 6 (e.g., EtherCAT, PROFINET, ModBus) and can translate I/O values into messages that can be transmitted via channels. This module can be used on an edge device 3 that has direct access to sensors 9 and actuators 7. In order to implement that the method can provide an API that makes access to the industrial field bus 6 that provides these values possible. The access to I/O values may therefore be abstracted by an active query mechanism by reading values at the beginning of each control cycle to form a push communication concept, i.e., channel reading and channel writing. The channels can thus receive each value change and store this value so that the control application can be executed with the latest value.

Various communication methods, for example a publish/subscribe communication stack, may be used behind the channel concept so that transmitter and receiver are completely decoupled. However, the same concept may also be possible with a client-server communication protocol or a shared memory if the vPLC 1′ module is executed directly on the node with access to the sensor/actuator 7. A second-stage translator may use the translated C files and header files as input and generate glue code for each IN, OUT, and IN OUT variable in order to generate a topic and a corresponding channel in the I/O module 11. As soon as these modifications with respect to the header files have been implemented and the I/O module 11 has been generated, the translator can change the variable calls in the C files to the corresponding channel calls. The channel concept may require specific IDs for each input variable and output variable in order to properly pack and unpack the input values and output values. Additionally, access to the variables (I/O variables) may have to be replaced by channel access.

As soon as the I/O module 11 has been generated and the vPLC 1′ module has been modified with the channel access, the method can generate a specific validator component 5. The method can therefore generate C code that reads the channels from the I/O module 11 that would write the output values/control values into the industrial field bus 6. In a first step, these channels may be marked with output suppression so that only the original PLC module writes output values/control values into the industrial field bus 6. The generated validator component 5 may be equipped with a user-defined delta for the various control values so that the comparison part of the validator component 5 can accept small differences in the control values generated by the vPLC 1′ module in comparison to the original code. If the user 8 does not provide such a delta for the control values/output values, the validator component 5 may compare the outputs for equality and mark them as “ok” only if the output values/control values of the two components are equal. The validator component 5 may be equipped with a simple user interface (e.g., a screen output), which may provide feedback to the user 8 as soon as the vPLC 1′ module generates the same outputs or the difference in the outputs is less than the given delta.

As soon as the modifications and translations of the C code are completed, the migratable application, I/O module 11, and/or validator component 5 may be compiled into a low-level binary command format for a stack-based virtual machine, e.g., WebAssembly. By using this bytecode virtualization, it may be possible to implement a fast execution of the module while being independent of specific hardware and specific operating systems.

In a next step, the compiled vPLC 1′ bytecode modules may be deployed via the orchestrator 12 on an available edge device 3 or on different edge devices 3, depending on availability, utilization, etc. of the available edge nodes. The orchestrator 12 may ensure that the vPLC 1′ module is deployed in a so-called non-write mode, i.e., with output suppression. This mode can prevent the outputs generated by the vPLC 1′ module from being written to the actuators 7 via the I/O module 11. Such a non-write mode may be important since the migratable application could otherwise modify the actuators 7 at the same time since the application may still be executed on the PLC.

As soon as the migratable application is deployed and outputs (O_{VPLC}) are generated, the generated validator component 5 can begin to compare the outputs O_{VPLC} to the outputs generated by the application O_{PLC}. As described above, the user 8 may optionally define a delta for the different control values/output values generated by the vPLC 1′ module, i.e., the migratable application. The validator component 5 may therefore define a difference less than the delta as positive and the validation may be ok. Scenarios for the next steps are possible on the basis of the result of the validation.

If there is a difference (the difference is greater than the given delta if a delta is provided), this can indicate possible different internal states of the used functions and modules between the PLC module, i.e., the application, and the virtualized PLC module, i.e., the migratable application. In order to resolve this delta in the outputs, the validator component 5 may initiate a state transmission between the original PLC program, i.e., the application, and the virtualized PLC module, i.e., the migratable application. Extracting the state, transmitting, and writing the values into the memory of the bytecode virtualization may have to take place within an execution cycle of the original PLC module, e.g., 2 ms or more slowly, depending on the execution cycle. The state may comprise both internally used variables within the PLC module and internal variables of the function modules used. In the case of an internal PID (proportional-integral-differential) control loop, this may, for example, be the integral, the derivative, or the process variable. Extracting such internal variables may take place via the available memory access APIs provided by the PLC. The transmission may take place via the orchestrator 12 and with the highest priority on the network.

The values may then be written back into the memory of the low-level binary format. Depending on the technology used, the exported functions of WebAssembly or of a particular Web API could be implemented if WebAssembly is used to implement the runtime 2 and the execution modules. Nevertheless, the orchestrator 12 must ensure in any case that the state transmission can be implemented within the cycle buffer time. The execution cycle may be 10 ms. The time it takes the PLC program, i.e., the application, to execute the logic and calculate the outputs may be 5 ms. The cycle buffer time can subsequently be calculated. The orchestrator 12 may prioritize the state transmission by temporarily modifying resource allocations if there is more CPU reservation, available memory, etc. for the runtimes 2 involved. In any case, a state transmission may be initiated only if a time to extract the state, a transmission time between the PLC and the vPLC 1′, i.e., between the application and the migratable application, and the time to write the values into the vPLC 1′ module is less than the execution cycle or the cycle buffer time.

If there is no difference between the results generated by the vPLC 1′ module and the original PLC, i.e., between the application and the migratable application, or the delta comparison between the results is within the specified limits, the orchestrator 12 may trigger the final step, step 8. If there are still differences in the output, the validator component 5 may trigger an error message that triggers further diagnosis by the user 8 with respect to other discrepancies in the vPLC 1′ module.

Via a small user interface, the validator component 5 may highlight that both modules generate the identical outputs/control values. Through the interaction with the validator component 5, the user 8 may initiate or approve the switch. On the basis of this input, the validator component may transmit the switch command to the orchestrator 12. The orchestrator 12 may wait until an execution cycle has ended, and then initiate the shutdown of the PLC while switching the execution runtime 2 module to write mode, whereby the suppression mode is deactivated. This may mean that the outputs generated by the execution runtime 2 module are now published via the channels to the actuators 7. The translation of the classical PLC program into virtualized operating-system-agnostic and HW-agnostic vPLC 1 execution runtime 2 modules has been carried out.

The above explanation of the embodiments describes the present invention with reference to examples. Of course, individual features of the exemplary embodiments may be freely combined with one another, if technically meaningful, without leaving the scope of the present invention.

What is claimed is:

1. A method for deploying a migratable application for a programmable logic controller, comprising the following steps:
converting an application of the programmable logic controller to a general-purpose programming language;
modifying the converted application using the general-purpose programming language to generate at least one access module to make access of the converted application to at least one sensor and/or at least one actuator possible;
compiling the modified application into a bytecode format in order to deploy the migratable application;
executing the migratable application and the application in order to provide an output of the migratable application and an output of the application;
validating the migratable application based on a comparison of the output of the migratable application with the output of the application in order to provide a validation result; and
deploying the validated migratable application on the programmable logic controller, wherein the deployment depends on the validation result.

2. The method according to claim 1, wherein that deployment of the validated migratable application on the programmable logic controller is carried out after an execution cycle of the programmable logic controller and within a time period that is smaller than a buffer time of the programmable logic controller.

3. The method according to claim 1, wherein the at least one access module is generated to provide access to an industrial field bus, wherein access to the industrial field bus is provided by a translation of values of the industrial field bus into messages for the migratable application, in order to make access to the at least one sensor and/or the at least one actuator using the industrial field bus possible.

4. The method according to claim 3, wherein the access to the industrial field bus is also provided by a translation of messages from the migratable application to values for the industrial field bus.

5. The method according to claim 3, wherein the method further comprises the following step:
generating a validator component for carrying out the validation, wherein the validator component is generated to read the output of the migratable application and the output of the application, wherein output suppression for the migratable application is initiated so that only the application writes values to the industrial field bus.

6. The method according to claim 1, wherein the validating further comprises the following steps:
defining a threshold value for a deviation of the output of the migratable application from the output of the application; and
comparing a current deviation of the output of the migratable application from the output of the application with the defined threshold value in order to provide the validation result.

7. The method according to claim 1, wherein the method further comprises the following step:
initiating feedback, wherein the feedback indicates a result of the validation.

8. The method according to claim 1, wherein the method further comprises the following step:
initiating a state transmission between the application and the migratable application, wherein initiation depends on the validation result, wherein the state transmission includes transmission: (i) of at least internally used variables within the programmable logic controller, and/or (ii) of internal variables of at least one function module used by the application.

9. A data processing device configured to deploy a migratable application for a programmable logic controller, the data processing device configured to:
convert an application of the programmable logic controller to a general-purpose programming language;
modify the converted application using the general-purpose programming language to generate at least one access module to make access of the converted application to at least one sensor and/or at least one actuator possible;
compile the modified application into a bytecode format in order to deploy the migratable application;
execute the migratable application and the application in order to provide an output of the migratable application and an output of the application;
validate the migratable application based on a comparison of the output of the migratable application with the output of the application in order to provide a validation result; and
deploy the validated migratable application on the programmable logic controller, wherein the deployment depends on the validation result.

10. A non-transitory computer-readable storage medium on which are stored instructions deploying a migratable application for a programmable logic controller, the instructions, when executed by a computer, causing the computer to perform the following steps:
converting an application of the programmable logic controller to a general-purpose programming language;
modifying the converted application using the general-purpose programming language to generate at least one access module to make access of the converted application to at least one sensor and/or at least one actuator possible;
compiling the modified application into a bytecode format in order to deploy the migratable application;
executing the migratable application and the application in order to provide an output of the migratable application and an output of the application;
validating the migratable application based on a comparison of the output of the migratable application with the output of the application in order to provide a validation result; and
deploying the validated migratable application on the programmable logic controller, wherein the deployment depends on the validation result.
